(19) United States
(12) Patent Application Publication
(10) Pub. No.: US 2003/0063351 A1
(43) Pub. Date: Apr. 3, 2003

(54) Microtransponder sensing system

(76) Inventors: Wlodek Mandecki, Princeton Junction, NJ (US); Hananel H. Davidowitz, Princeton, NJ (US); Vladimir R. Furman, Plainsboro, NJ (US)

Correspondence Address: BRINKS HOFER GILSON & LIONE, P.O. BOX 10395, CHICAGO, IL, 60610, US

(21) Appl. No.: 09/970,430

(22) Filed: Oct. 2, 2001

(51) Int. Cl. H04B 10/08; H04B 10/12

(52) U.S. Cl. 359/173; 359/110

(57) ABSTRACT

A microtransponder sensing system having a light source and receiver device. The light source provides a light signal that is positioned with the receiver device and in relation to a microtransponder. The microtransponder transmits an output signal in response to the light signal. The receiver device receives the output signal.

### CROSS REFERENCE

This application was filed on the same day as the following co-pending and commonly assigned U.S. patent application, which relates to and further describes other aspects of the embodiments disclosed in this application and is incorporated by reference in its entirety:

U.S. patent application Ser. No. _______, entitled AN IDENTIFICATION SYSTEM HAVING AN IDENTIFIABLE OBJECT WITH A PHOTO-ACTIVATED MICROTRANSPONDER, having Attorney Reference Number 7295/50, filed on Oct. 2, 2001, and is now U.S. Pat. No. ______.

### FIELD

This invention generally relates to systems for sensing radio frequency signals. More particularly, this invention relates to systems for sensing radio frequency signals produced by photo-activated microtransponders.

### BACKGROUND

A transponder sensing system usually transmits a transmission request to a transponder and receives a response from the transponder indicating the transponder is present. Transponders typically are wireless communication devices that receive and respond to an incoming signal. Transponders are used in a variety of applications to identify items such as wildlife, luggage, casino game pieces, and various retail goods such as clothing, compact disks, and the like. Usually, the transponder is attached to the item to be identified.

The transponder sensing system usually is designed for a particular type of transponder. Transponders may be active or passive electronic circuits. An active transponder essentially is in an “on” state all the time and typically uses a radio frequency system. An active transponder transmits information stored in the transponder in response to a transmission request. Active transponders usually can be operated without visual contact and may transmit a description of the item to which the tag is affixed. A passive transponder is essentially in an “off” state all the time and is usually activated and powered by an external means. Some passive transponders have passive elements that respond only when placed in the appropriate radio frequency (RF) or magnetic field. These passive transponders, also called tags due to their ability to “tag” a retail item to prevent shoplifting, are deactivated when a product is purchased.

The size of many transponders interferes with the use of an item if the transponder is attached. Many active transponders have batteries, an internal oscillator, and/or an external antenna that restrict the ability to reduce the size of the transponder. Passive transponders typically have a larger size to enable the transponder to interact properly and be detected by the RF or magnetic field.

Microtransponders often are affixed to an article for identification without affecting use of the article. A microtransponder usually has dimensions less than about 1 millimeter and is powered by light using a photovoltaic cell—an electronic device that converts light into electricity. A microtransponder typically transmits a signal in response to light activating the photovoltaic cell.

A microtransponder sensing device usually has a light source and receiver device. To detect the signal from the transponder, the receiver device and light source are positioned to activate the transponder and receive the signal from the transponder. The receiver device and light source need to be properly positioned for activation of the transponder and reception of the signal from the transponder. The effective range of the signal transmission from a microtransponder usually is less than 10 millimeters. A photo-activated transponder is inactive without light illumination and has to receive a certain amount of light energy to properly activate or to transmit data. The amount of light energy received by a photo-activated transponder is affected by many factors such as the surface area of the photovoltaic cell, the wavelength of the light, the intensity of the light source, the distance of the light source from the photovoltaic cell, and the focus of the light source.

The receiver device and light source may take several attempts to be positioned properly. If the receiver device were not properly positioned, the light source might activate the transponder but the receiver device would not receive the signal. If the light source were not properly positioned, the light source would not activate the transponder so no signal would be generated. Additionally, the time to reposition the light source and the receiver device increases the time and cost of using a microtransponder sensing device.

### SUMMARY

The invention provides a microtransponder sensing system for positioning a light signal and a receiver device in relation to a microtransponder. The microtransponder transmits an output signal in response to the light signal. The receiver device receives the output signal.

In one aspect, the microtransponder sensing system has a light source, a light conduit, and a receiver device. The light conduit is operatively connected to the light source. The light conduit conveys a light signal to a light output area. The receiver device is positioned at a first distance from the light conduit in the light output area. The receiver device receives an output signal in response to the light signal.

In another aspect, the microtransponder sensing system has a base unit, a remote unit, and a light conduit. The base unit has a light source. The remote unit has an antenna and at least one shim having an edge. The remote unit forms a view port. A light conduit is operatively connected to the light source. The light conduit is disposed to convey a light signal to the view port. The light conduit is positioned at a first distance from the antenna. The light conduit is positioned at a second distance from the edge. The antenna receives an output signal in response to the light signal.

Other systems, methods, features, and advantages of the invention will be or will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE FIGURES

The invention may be better understood with reference to the following figures and detailed description. The components in the figures are not necessarily to scale, emphasis being placed upon illustrating the principles of the invention. Moreover, like reference numerals in the figures designate corresponding parts throughout the different views.

FIG. 1 represents a perspective view of a microtransponder sensing system according to one embodiment.

FIG. 2 represents a block diagram of a microtransponder sensing system according to one embodiment.

FIG. 3 represents a bottom view of a remote unit for a microtransponder sensing system according to one embodiment.

FIG. 4 represents a bottom view of a remote unit for a microtransponder sensing system according to another embodiment.

FIG. 5 represents a front end view of the remote unit shown in FIG. 4.

FIG. 6 represents a front and side perspective view of the remote unit shown in FIG. 4.

FIG. 7 represents a block diagram of a microtransponder sensing system according to another embodiment.

### DETAILED DESCRIPTION OF THE PREFERRED EMBODIMENTS

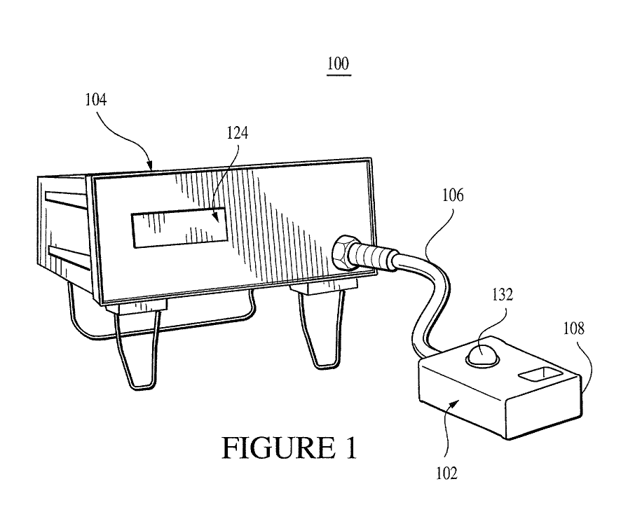

FIG. 1 represents a perspective view of a microtransponder sensing system 100 according to one embodiment. The microtransponder sensing system 100 comprises a handheld unit 102 connected to a base unit 104 via a cable 106. The handheld unit 102 has a view port 108 and an activation key 132. The base unit 104 has a display 124. The view port 108 may have various configures with one or more sides (not shown).

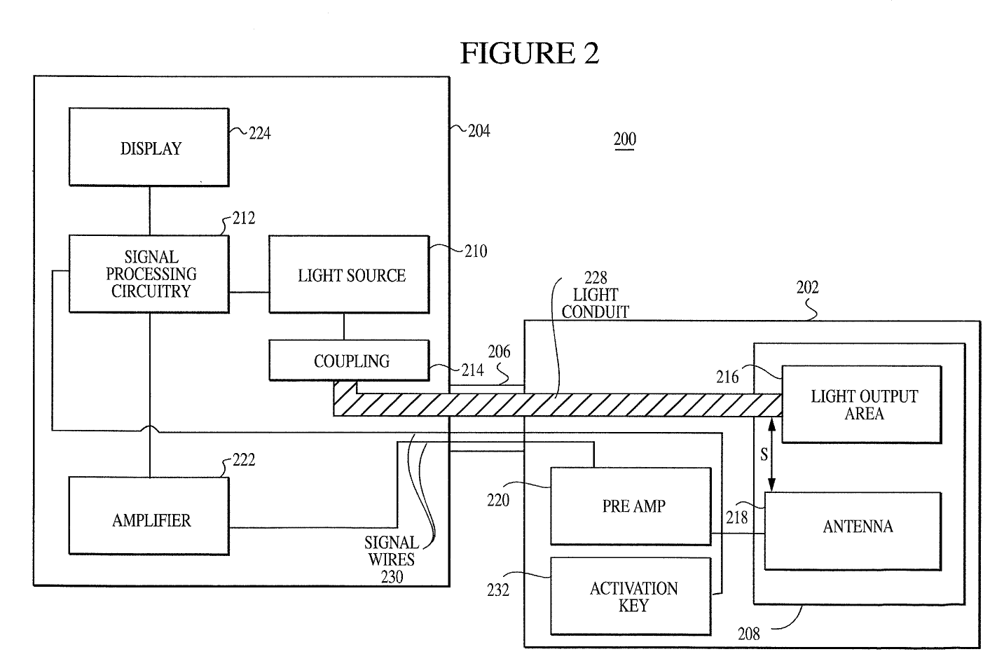

FIG. 2 represents a block diagram of a microtransponder sensing system 200 according to one embodiment. The microtransponder sensing system 200 has a remote unit 202 connected via a cable 206 to a base unit 204 operatively. The cable 206 comprises a casing surrounding a light conduit 228 and signal wires 230. The cable 206 may have other configurations including those without a casing. The cable may have one or more signal wires and may not have any signal wires depending upon the connections between the components and their configurations in the microtransponder sensing system 200. Operatively connected includes optical and electrical interfaces for communication and interaction of the various components using optical fibers, wires, radio signals, and the like. While various configurations are shown, the microtransponder sensing system 100 and 200 may have other configurations including those with fewer, additional, or other components.

The base unit 204 has signal processing circuitry 212 operatively connected to a display 224, a light source 210, and an amplifier 222. The signal processing circuitry 212 preferably has a field programmable gate array (FPGA) and a digital signal processing (DSP) chip, which are not shown. The display 224 may be a liquid crystal display (LCD) or the like. The light source 210 may comprise multiple and different light sources such as a light amplification by stimulated emission of radiation (LASER) diode, a light emitting diode (LED), and the like. In one aspect, the light source 210 has a wavelength in the range of about 500 nanometers through about 1,200 nanometers. In another aspect, the light source 210 has a wavelength in the range of about 670 nanometers through about 690 nanometers. Other wavelengths may be used. A coupling 214 joins a light conduit 228 to the light source 210. The coupling 214 comprises an aspheric coupling optic, but other joining devices may be used. The light conduit 228 is an optical fiber, but may be another light conveyance device. In one aspect, the light conduit 228 is an optical fiber having a diameter in the range of about 100 micrometers to about 1,000 micrometers. In another aspect, the light conduit 228 is a multimode optical fiber having a diameter of about 200 micrometers.

The remote unit 202 has a preamplifier 220 operatively connected to an antenna 218. The preamplifier 220 is operatively connected to the amplifier 222 in the base unit 204 via one of the signal wires 230. In one aspect, the antenna 218 is a modified inductor in which the windings have been reduced for matching the impedance of the antenna 218 with other components in the microtransponder sensing system 200. The antenna 218 may have other coil configurations and other signal reception configurations. The antenna 218 is configured to receive radio frequency signals, but may be configured to respond to changes in a magnetic field. The antenna 218 may be any receiver device including a receiver device configured to receive optical signals. The preamplifier 220 and amplifier 222 may comprise one or more amplifiers, which may be incorporated into a single amplifier circuit and disposed in either of the base unit 204 or the remote unit 202.

The remote unit 202 also has an activation key 232 operatively connected to the signal processing circuitry 212 via one of the signal wires 230. The activation key 232 may be a button, sensor, switching device, or the like that sends a control signal to the signal processing circuitry when depressed or otherwise activated.

The light conduit 228 and antenna 218 are operatively disposed in a view port 208 formed by the remote unit 202. The remote unit 202 may have a magnifying lens (not shown) or other transparent material covering the view port 228. The light conduit 228 and the antenna 218 are disposed a distance “s” from each other. In one aspect, the distance “s” is less than about 5 millimeters. In another aspect, the distance “s” is about 1 millimeter. In a further aspect, the distance “s” is about zero. In this aspect, the light conduit 228 and antenna 218 are essentially in contact with each other. The light conduit 228 and antenna 218 also may form an integrated component (not shown) such as when antenna 218 comprises a coil configuration and the light conduit 228 extends through the coil configuration.

In one aspect, the remote unit 202 may have one or more spacers or shims (not show) as discussed below. The shims may be used to position the light conduit 228 and the antenna 218 at a particular distance above a microtransponder. The shims may connect directly to the light conduit 228 and antenna 218. In another aspect, the remote unit 202 may not have any shims.

In operation, an item (not shown) with a microtransponder (not shown) is positioned for the microtransponder sensing system 100 and 200 to identify the microtransponder. The item may comprise paper, fabric, metal, plastic, another material, or a combination thereof. The transponder may be disposed on or in the item such that it may be accessed by the microtransponder sensing system 100 and 200. The item may be positioned on a relatively flat surface such as a table. The item may have suitable form and substance for the microtransponder sensing system 100 and 200 to operate without a table or other support.

The microtransponder sensing system is powered-up and the light source 210 is turned-on. The light source 210 produces a light signal that is conveyed through the coupling 214 and light conduit 228 and thus illuminates the light output area 216 in the remote unit 202. In one aspect, the signal processing circuitry 212 provides a clock signal to the light source 210. The clock signal modulates the light signal. The modulated light signal has a carrier wave and a modulated wave. The carrier wave would generate power in a microtransponder. The modulated wave would generate a clock signal in the microtransponder. In this aspect, a microtransponder is activated by both the modulated and carrier waves.

The remote unit 202 is positioned on the item to locate the microtransponder in the view port 208. The microtransponder is aligned with the light conduit 228 in the light output area 216. Other alignments may be used. As discussed below, the alignment of the microtransponder with the light conduit 228 positions the light signal properly for activation of the microtransponder. The distance “s” also positions the antenna 218 properly for reception of an output signal from the microtransponder.

Once the microtransponder is aligned, the microtransponder is activated and it begins to emit a radio frequency signal containing microtransponder identification or other data. The output signal may be an optical, magnetic, or another type of signal. The output signal also may be a modulated signal and a coded signal. In one aspect, the microtransponder emits a cyclic redundancy code for identifying possible errors in the microtransponder identification or other data. The activation key 232 is pressed or otherwise activated. The activation key 232 indicates to the signal processing circuitry 212 that the remote unit 202 is in position for the antenna 218 to receive the output signal from the microtransponder.

The signal processing circuitry 212 receives the output signal from the antenna 218 through the preamplifier 220 and amplifier 222, which amplify the output signal about 100,000 times. Other amplification circuitry and amounts may be used. Within the signal processing circuitry 212, the identification code or other data is extracted from the output signal and checked for errors. If the output signal is coded, the output signal is decoded. The output signal may process in real time or at another time. The signal processing circuitry 212 shows the data from the microtransponder on the display 224. The data may provide an identification code of the transponder or the item and other or different information. The signal processing circuitry 212 may store the data in a data storage device (not shown) such as an internal memory and an external data storage device. In one aspect, the signal processing circuitry 212 beeps or otherwise indicates a successful capture of the output signal.

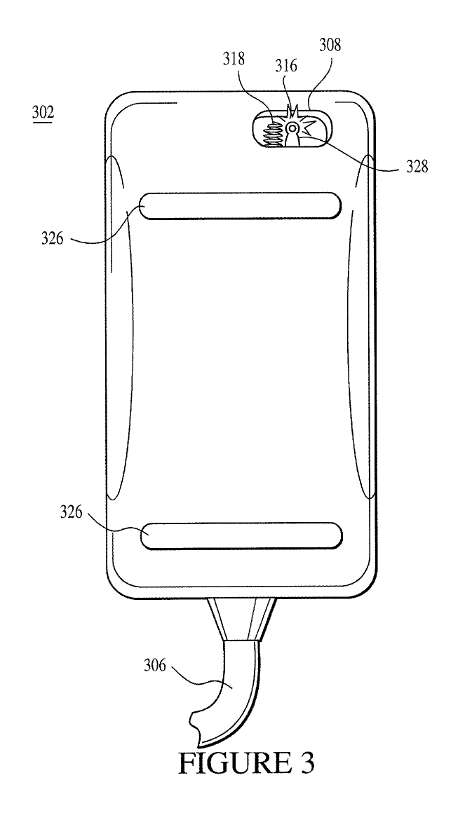

FIG. 3 represents a bottom view of a remote unit 302 for a microtransponder sensing system according to one embodiment. The remote unit 302 is connected to a base unit (not shown) via cable 306. The remote unit 302 has a light conduit 328 and an antenna disposed in a view port 308 as previously discussed. The view port 308 is formed by the remote unit 302, which encloses the view port 308. In one aspect, the remote unit 302 has spacers or shims 326, which position the light conduit 328 and antenna 318 above a microtransponder as discussed below. One or more spacers or shims 326 may be used. The shims 326 may be an adhesive or otherwise attachable strip and may be formed by the remote unit 302. In one aspect, the shims 326 are an adhesive strip comprising polytetrafluoroethylene. The shims 326 support the remote unit 302, which supports the light conduit 328 and the antenna 318. The shims 326 may have other configurations including a direct connection to the light conduit 328 and the antenna 318.

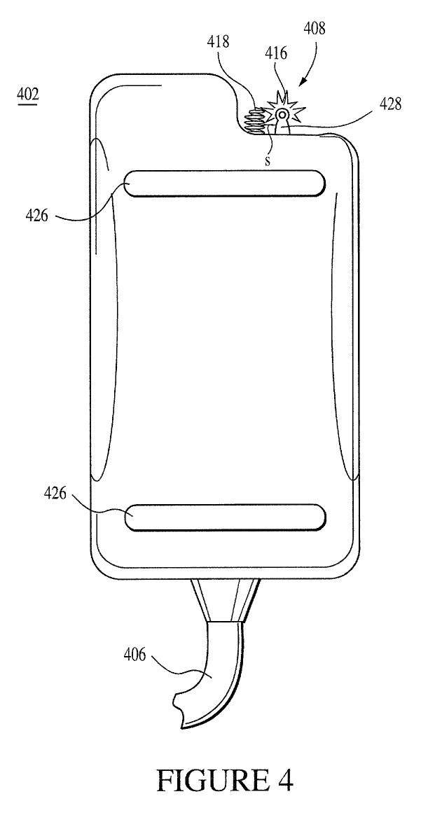

FIG. 4 represents a bottom view of a remote unit 402 for a microtransponder sensing system according to another embodiment. The remote unit 402 is connected to a base unit (not shown) via cable 406. The remote unit 402 has a light conduit 428 and an antenna 418 disposed in a view port 408 as previously discussed. The view port 408 is formed by the remote unit 402 and has a notch-like configuration. The remote unit 402 partially encloses the view port 408, which may have other configurations. The remote unit 402 has spacers or shims 426, which position the light conduit 428 and antenna 418 above a microtransponder as discussed. One or more spacers or shims 426 may be used as previously discussed.

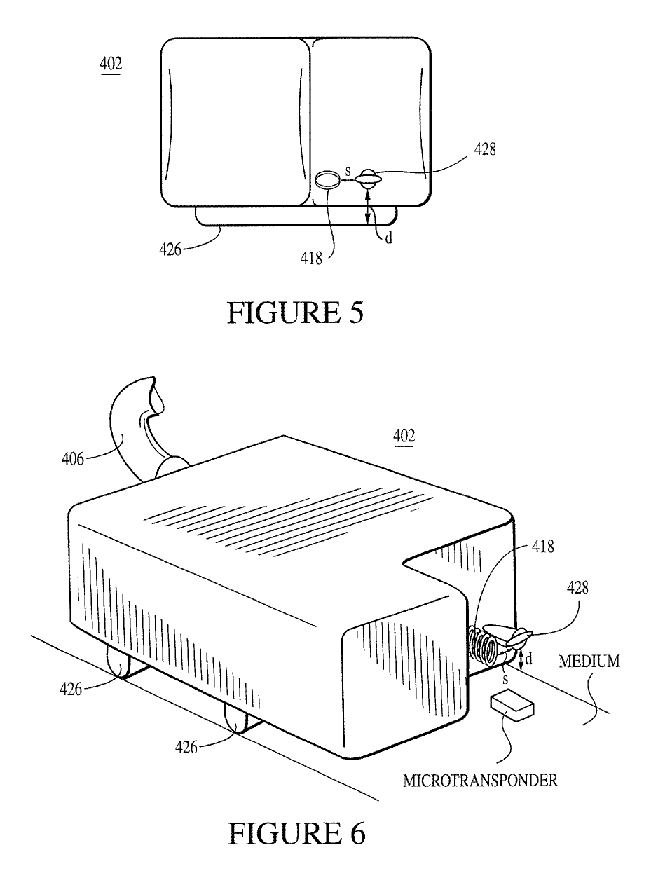

FIGS. 5 and 6 represent other views of the remote unit 402 shown in FIG. 4. FIG. 5 represents a front end view. FIG. 6 represents a front and side perspective view. The various components are as discussed in FIG. 4.

In FIG. 5, the light conduit 428 and the antenna 418 are positioned a distance “s” from each other. The distance “s” may be less than about 5 millimeters and may be about 1 millimeter. The distance “s” can vary and may be about zero. The light conduit 428 also is positioned a distance “d” from a bottom edge of the spacers or shims 426. The distance “d” can vary and even may be about zero. In one aspect, the distance “d” is less than about 5 millimeters. In another aspect, the distance “d” is about 1 millimeter. The antenna 418 may be positioned the same distance “d” as the light conduit 428 from the bottom edge of the spacers. However, the antenna 418 may be positioned at a different distance than distance “d” from the bottom edge of the spacers.

In FIG. 6, the remote unit 402 is positioned on a medium with a microtransponder. The medium may be paper or any of the items previously discussed. The medium essentially aligns with the bottom edge of the shims 426. Distance “d” is essentially the distance from the light conduit 428 to the medium.

The distance “s” and the distance “d” are selected such that when the light conduit 428 is aligned with the microtransponder in the view port, light conduit 428 is in position to activate the microtransponder and the antenna 418 is in position to receive an output signal from the microtransponder. Other distances and alignments may be used to align the light conduit 428 and the antenna 418 for operation with the microtransponder. In one aspect, the distance “s” is less than about 1 millimeters and the distance “d” is about 1 millimeters. In another aspect, at least one of the distance “s” and the distance “d” is about zero. While appearing flat, the remote unit 402 and the medium may be curved and have other shapes and configurations. The light conduit 428 and antenna 418 may be positioned at various angles above the microtransponder. In one aspect the light conduit 428 and antenna 418 are placed at in the range of about 80 through about 90 degrees above the microtransponder 430.

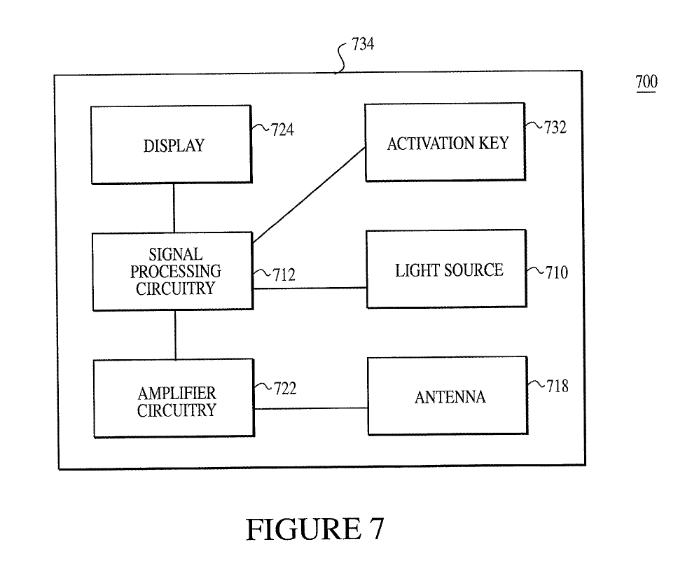

FIG. 7 represents a block diagram of a microtransponder sensing system 700 according to another embodiment. In the microtransponder sensing system 700, the remote and base units previously discussed are combined into an integrated unit 734. The integrated unit 734 has signal processing circuitry 712 operatively connected to a display 724, a light source 710, an antenna 718, amplifier circuitry 722, and an activation key 732. The light source 710 may be joined to a light conduit (not shown) via a coupling (not shown). The antenna 718 and light conduit are disposed in a view port (not shown). The antenna 718 and the light source 710 also may be disposed in the view port. In one aspect, the integrated unit 734 is a portable or hand-held unit, which may be passed over an item with a transponder. In another aspect, the integrated unit 734 is a relatively stationary or stand-alone unit in which items with transponders are passed over the integrated unit 734.

Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. A microtransponder sensing system comprising:
a light source;
a light conduit operatively connected to the light source, the light conduit to convey a light signal from a light source to a light output area; and
a receiver device positioned at a first distance from the light conduit in the light output area, the receiver device to receive an output signal in response to the light signal.

2. The microtransponder sensing system according to claim 1, where the first distance is less than about 5 millimeters.

3. The microtransponder sensing system according to claim 2, where the first distance is about 1 millimeter.

4. The microtransponder sensing system according to claim 1, where the light signal is a modulated signal.

5. The microtransponder sensing system according to claim 1, where the output signal is a radio frequency signal.

6. The microtransponder sensing system according to claim 1, where the light conduit comprises an optical fiber.

7. The microtransponder sensing system according to claim 6, where the optical fiber has a diameter in the range of about 100 micrometers to about 1,000 micrometers.

8. The microtransponder sensing system according to claim 7, where the optical fiber has a diameter of about 200 micrometers.

9. The microtransponder sensing system according to claim 1, where the light source comprises at least one of a light amplification by stimulated emission of radiation (LASER) and a light emitting diode (LED).

10. The microtransponder sensing system according to claim 1, where the light source has a wavelength in the range of about 500 nanometers to about 1,200 nanometers.

11. The microtransponder sensing system according to claim 10, where the light source has a wavelength in the range of about 670 nanometers to about 690 nanometers.

12. The microtransponder sensing system according to claim 1, where the receiver device is a modified inductor.

13. The microtransponder sensing system according to claim 1, further comprising at least one shim connected to the light conduit and to the receiver device, the shim having an edge, the light conduit positioned at a second distance from the edge.

14. The microtransponder sensing system according to claim 13, where the receiver device is positioned at the second distance from the edge.

15. The microtransponder sensing system according to claim 13, where the second distance is less than about 5 millimeters.

16. The microtransponder sensing system according to claim 15, where the second distance is about 1 millimeter.

17. The microtransponder sensing system according to claim 13, where at least one of the first distance and the second distance is about zero.

18. The microtransponder sensing system according to claim 1, further comprising signal processing circuitry operatively connected to receive the output signal from the receiver device.

19. The microtransponder sensing system according to claim 18, further comprising a display operatively connected to the signal processing circuitry.

20. The microtransponder sensing system according to claim 19, where the display comprises a liquid crystal display.

21. The microtransponder sensing system according to claim 1, further comprising amplifier circuitry operatively connected to the receiver device and to the signal processing circuitry.

22. The microtransponder sensing system according to claim 21, where the amplifier circuitry comprises at least one preamplifier and at least one amplifier.

23. The microtransponder sensing system according to claim 21, where the amplifier circuitry amplifies the output signal by about 100,000 times.

24. The microtransponder sensing system according to claim 1, where the microtransponder sensing system comprises an integrated unit.

25. A microtransponder sensing system comprising:
a base unit comprising a light source;
a remote unit comprising an antenna and at least one shim having an edge, the remote unit forming a view port; and
a light conduit operatively connected to the light source, the light conduit disposed to convey a light signal from the light source to the view port;
where the light conduit is positioned at a first distance from the antenna, where the light conduit is positioned at a second distance from the edge, and
where the antenna receives an output signal in response to the light signal.

26. The microtransponder sensing system according to claim 25, where the antenna is positioned at the second distance from the edge.

27. The microtransponder sensing system according to claim 25, where at least one of the first distance and the second distance is less than about 5 millimeters.

28. The microtransponder sensing system according to claim 27, where at least one of the first distance and second distance is about 1 millimeter.

29. The microtransponder sensing system according to claim 27, where at least one of the first distance and second distance is about zero.

30. The microtransponder sensing system according to claim 25, where the output signal is a radio frequency signal.

31. The microtransponder sensing system according to claim 25, where the light conduit comprises an optical fiber.

32. The microtransponder sensing system according to claim 25, where the light source comprises at least one of a light amplification by stimulated emission of radiation (LASER) and a light emitting diode (LED).

33. The microtransponder sensing system according to claim 25, further comprising signal processing circuitry connected to the light source, the signal processing circuitry operatively connected to receive the output signal from the antenna.

34. The microtransponder sensing system according to claim 33, where the signal processing circuitry provides a clock signal to the light source, where the light source provides a modulated light signal in response to the clock signal.

35. The microtransponder sensing system according to claim 33, further comprising a display connected to the signal processing circuitry.

36. The microtransponder sensing system according to claim 33, further comprising an amplifier in the base unit operatively connected to a preamplifier in the remote unit, the preamplifier operatively connected to the antenna, the amplifier operatively connected to the signal processing circuitry.

37. A microtransponder sensing system comprising:
a light source; and
a receiver device positioned at a first distance from the light source, the receiver device to receive an output signal in response to a light signal from the light source.

38. The microtransponder sensing system according to claim 37, where the first distance is about 1 millimeter.

39. The microtransponder sensing system according to claim 37, where the light signal is a modulated signal.

40. The microtransponder sensing system according to claim 37, where the output signal is a radio frequency signal.

41. The microtransponder sensing system according to claim 37, where the light source has a wavelength in the range of about 500 nanometers to about 1,200 nanometers.

42. The microtransponder sensing system according to claim 37, further comprising at least one shim connected to the light source and to the receiver device, the shim having an edge, the light source positioned at a second distance from the edge.

43. The microtransponder sensing system according to claim 42, where the receiver device is positioned at the second distance from the edge.

44. The microtransponder sensing system according to claim 42, where the second distance is about 1 millimeter.

45. The microtransponder sensing system according to claim 42, where at least one of the first distance and the second distance is about zero.

46. The microtransponder sensing system according to claim 37, where the microtransponder sensing system comprises an integrated unit.
